(19) United States
(12) Patent Application Publication
(10) Pub. No.: US 2013/0312261 A1
(43) Pub. Date: Nov. 28, 2013

(54) METHOD FOR PRODUCING A REINFORCED METAL PART, SUCH AS A REINFORCEMENT FOR A TURBINE-ENGINE BLADE

(71) Applicants: Thierry Godon, Sevran (FR); Bruno Jacques Gérard Dambrine, Le Chatelet-en-Brie (FR)

(72) Inventors: Thierry Godon, Sevran (FR); Bruno Jacques Gérard Dambrine, Le Chatelet-en-Brie (FR)

(73) Assignee: SNECMA, Paris (FR)

(21) Appl. No.: 13/982,961

(22) PCT Filed: Jan. 31, 2012
(86) PCT No.: PCT/FR12/50199

§ 371 Date: Jul. 31, 2013

(30) Foreign Application Priority Data
Feb. 1, 2011 (FR) 1150781

(51) Int. Cl. B23P 15/04

(52) U.S. Cl. CPC B23P 15/04
USPC 29/889.71

(57) ABSTRACT

A method for producing a reinforced metal part, includes: cutting out a plurality of metal foils from at least one flexible metal sheet, the foils substantially corresponding to the blank of said metal part to be produced; rigidly connecting at least one metal reinforcing wire to at least one metal foil, the metal wire being positioned depending on the orientation of the desired structural reinforcement; making a plurality of reinforced metal pockets, each metal pocket being made from two reinforced metal foils; positioning the plurality of reinforced metal pockets in shaping equipment; performing a isostatically hot-pressing of the reinforced metal pockets, causing the metal pockets and the metal reinforcing wire to be bonded together so as to produce the metal part incorporating the structural reinforcement.

### TECHNICAL FIELD

This invention relates to a method of producing a reinforced metal part such as a metal reinforcement of a composite or metal turbine-engine blade.

More particularly, the invention relates to a method for producing a metal reinforcement for the leading edge or trailing edge of a turbine-engine blade.

The domain of the invention is turbine-engines and more particularly turbine-engine fan blades made of a composite or metal material, for which the leading edge comprises a metal stiffener protecting the blades.

However, the invention is also applicable to manufacturing a metal stiffener designed to reinforce a leading edge or trailing edge of any type of land or aeronautical turbine-engine blade, and particularly a helicopter engine turbine or an aircraft turbojet, but also propellers such as open rotor propellers.

The invention is also applicable to manufacturing of any solid metal part with a complex geometric shape.

Note that the leading edge corresponds to the forward part of an aerodynamic profile facing the airflow and that divides the airflow into an intrados airflow and an extrados airflow. The trailing edge corresponds to the rear part of an aerodynamic profile at which the intrados and extrados flows join together.

The turbine-engine blades, and particularly the fan blades, are subjected to high mechanical stresses dependent particularly on the rotation speed, and must satisfy strict weight and dimensional conditions. Consequently, blades made of composite materials that are lighter in weight are used in preference.

It is known that fan blades of a turbine-engine made of composite materials can be equipped with a metal structural reinforcement extending over the entire height of the blade and beyond their leading edge as disclosed in document EP1908919. Such reinforcement protects the composite blades at the time of an impact of a foreign body on the fan, for example such as a bird, hail or even pebbles.

In particular, the metal structural reinforcement protects the leading edge of the composite blade by preventing risks of delamination, rupture of fibres or damage by fibre/matrix decohesion.

Conventionally, a turbine-engine blade comprises an aerodynamic surface extending along a first direction between a leading edge and a trailing edge, and along a second direction approximately perpendicular to the first direction, between a root and a tip of the blade. The metal structural reinforcement matches the shape of the leading edge of the aerodynamic surface of the blade and extends along the first direction beyond the leading edge of the aerodynamic surface of the blade to match the profile of the intrados and extrados of the blade and along the second direction between the root and the tip of the blade.

In a known manner, the metal structural reinforcement is a metal part made entirely of titanium by milling from a block of material. The metal reinforcement is difficult to produce by milling and many reworking operations and complex tools are required requiring high manufacturing costs.

It is also known that metal parts with a complex shape such as a metal reinforcement for a turbine-engine blade can be made by stacking a series of thin flexible metal pockets in a shaping tool to make a preform of the part to be made, and by performing a Hot Isostatic Pressing (HIP) operation to obtain a compact part without porosity through a combination of plastic deformation, creep and diffusion welding.

The metal pockets are made by cutting metal foils with a geometry corresponding to the developed shape of the metal reinforcement to be made, starting from at least a thin metal sheet or foil, the foils then being fixed together so as to make a pocket that is easy to slide or assemble by insertion on a template or a shaping tool.

This method is disclosed more particularly in patent application FR2965498.

In some situations, a metal reinforcement of a turbine-engine blade has to be made comprising local stiffeners and/or thicknesses in order to improve mechanical properties of the blade stiffener.

In this context, the invention is aimed at disclosing a method of producing a reinforced metal part such as a reinforced metal reinforcement of a turbine-engine blade, starting from a plurality of metal foils in order to incorporate structural stiffeners capable of reinforcing the reinforcement as a function of these various mechanical loads; and eliminating the need for many reworking operations and the use of complex tools introducing high manufacturing costs for making a reinforced metal part such as a metal reinforcement of a turbine-engine blade.

To achieve this, the invention discloses a method of producing a reinforced metal part such as a metal reinforcement of a turbine-engine blade, comprising the following in sequence:
a step to cut out a plurality of metal foils corresponding approximately to the developed shape of said metal part to be made, from at least one flexible metal sheet,
a step to fix at least one metal stiffening wire on at least one metal foil among said plurality of foils, said metal wire being positioned as a function of the orientation of the required structural stiffener on the metal part to be made;
a step to make a plurality of reinforced metal pockets, each metal pocket being made from two reinforced metal foils,
a step to position said plurality of reinforced metal pockets in a shaping tool;
a hot isostatic pressing step of said reinforced metal pockets to cause bonding of said metal pockets and said metal stiffening wire so as to obtain said metal part including structural reinforcement means.

The term “foil approximately corresponding to the developed shape of said reinforced metal part” refers to a foil for which the general shape is similar to the general shape of the developed part to be made, but for which the dimensions are not necessarily the final dimensions of the reinforced metal part.

With the invention, the structural reinforcement of a complex shaped metal part such as a metal reinforcement of a turbine-engine blade is made simply and quickly using a plurality of flexible metal pockets comprising at least one metal wire ideally positioned so as to provide a directional structural stiffener of the part to be made as a function of needs, and a Hot Isostatic Pressing (HIP) process to obtain a compact part without porosity through a combination of plastic deformation, creep and diffusion welding.

The metal pockets used to make the part are made by cutting a plurality of metal foils with a geometry corresponding approximately to the developed shape of the part to be made, from at least one thin metal foil or sheet, the foils being fixed together so as to make a flexible metal pocket that is easy to slide or to assemble by insertion on a template or in a shaping tool.

This producing method can thus eliminate the need for complex manufacturing of the blade reinforcement by in-body milling, or broaching, using flats requiring a large volume of material and consequently high raw material costs, The method can also be used to easily make metal reinforcements that respect strict mass and/or geometry requirements.

According to one advantageous embodiment of the invention, the metal wire acting as a directional structural stiffener is sewn onto the metal foil by stitching means. The orientation of the seam of the metal wire is defined as a function of the desired orientation of the structural stiffener in the metal part to be made.

The method of producing a metal reinforcement for a turbine-engine blade according to the invention can also comprise one or more of the following features, considered individually or in any technically possible combination:
said method is a method of producing a metal reinforcement of a leading edge or trailing edge of a turbine-engine blade or a metal reinforcement of a propeller such that said reinforced metal part obtained during said isostatic pressing step is a reinforced metal reinforcement of a turbine-engine blade;
said step to make a plurality of metal pockets is done by superposition of two distinct metal foils and then by assembly of at least one edge of said metal foils by connecting means;
said step to make a plurality of metal pockets is done by folding a junction zone between two metal foils and then by assembling at least one edge of said two metal foils by connecting means;
said step to fix at least one metal stiffening wire onto at least one metal foil is done by sewing means;
said step to fix a metal stiffening wire onto at least one metal foil is done by gluing means and/or welding means;
said step to fix a metal stiffening wire onto at least one metal foil is done with a metal wire with a thickness varying between 0.05 mm and 0.3 mm;
said step to fix a metal stiffening wire onto at least one metal foil is done using a metal wire based on titanium and/or wire based on silicon carbide coated with titanium and/or wires based on silicon carbide coated with boron and/or wires based on silicon carbide coated with silicon carbide;
said step to position each of said reinforced metal pockets is done by stacking each of said reinforced metal pockets in a cavity of a die of said shaping tool;
said step to position each of said reinforced metal pockets is done by embedding each of said reinforced metal pockets in a plurality of notches arranged in a punch of said shaping tool.

Other advantages and characteristics of the invention will become clear after reading the description given below, for information and in no way imitative, with reference to the appended figures among which:

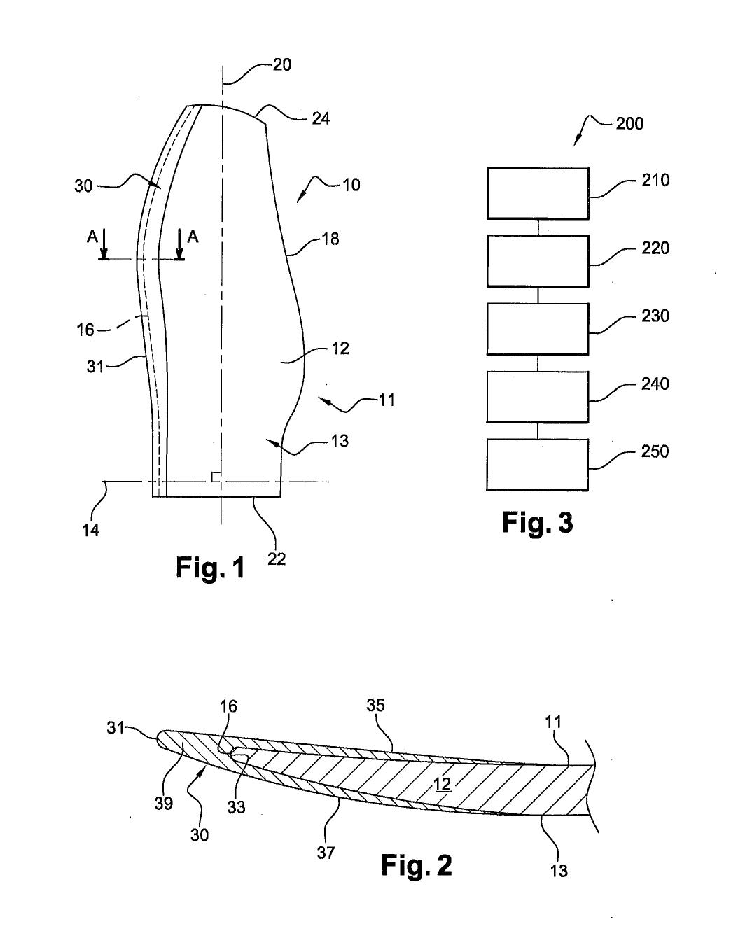

FIG. 1 is a side view of a blade comprising a metal structural reinforcement of a leading edge obtained by means of the manufacturing method according to the invention;

FIG. 2 is a partial sectional view of figure along a cut plane AA;

FIG. 3 is a block diagram presenting the main manufacturing steps of a metal structural reinforcement of a leading edge of a turbine-engine blade using the manufacturing method according to the invention;

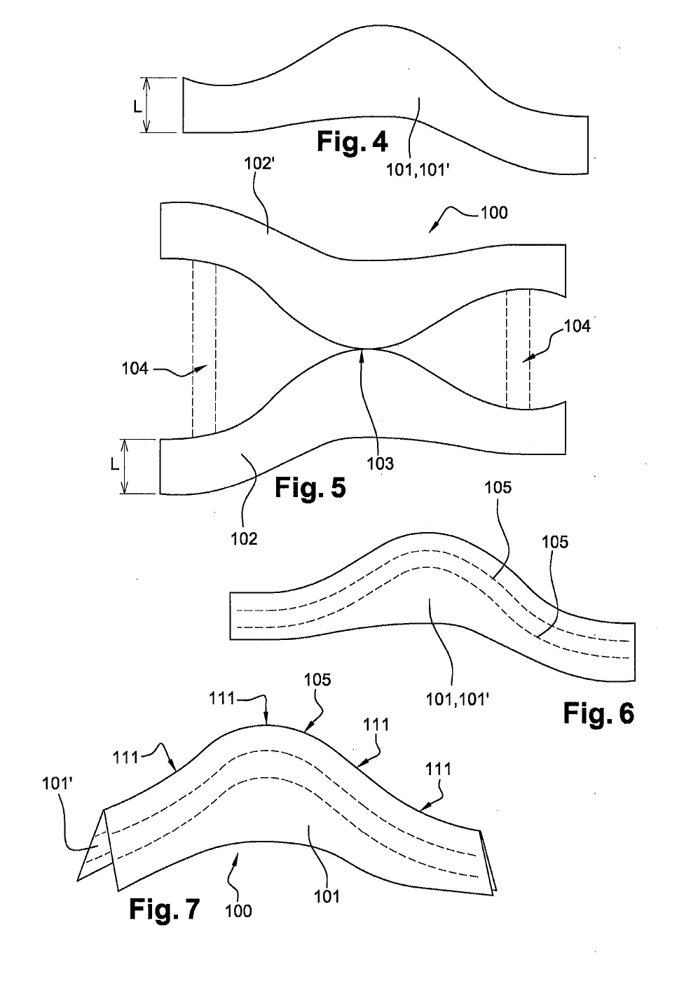

FIG. 4 shows a side view of the metal reinforcement of the leading edge of the turbine-engine blade according to a first example embodiment of the first step in the method shown in FIG. 3;

FIG. 5 shows a side view of the metal reinforcement of the leading edge of the turbine-engine blade according to a second example embodiment of the first step in the method shown in FIG. 3;

FIG. 6 shows a side view of the metal reinforcement of the leading edge of the turbine-engine blade obtained during the second step in the method shown in FIG. 3;

FIG. 7 shows a perspective view of the metal reinforcement of the leading edge of the turbine-engine blade obtained during the third step in the method shown in FIG. 3;

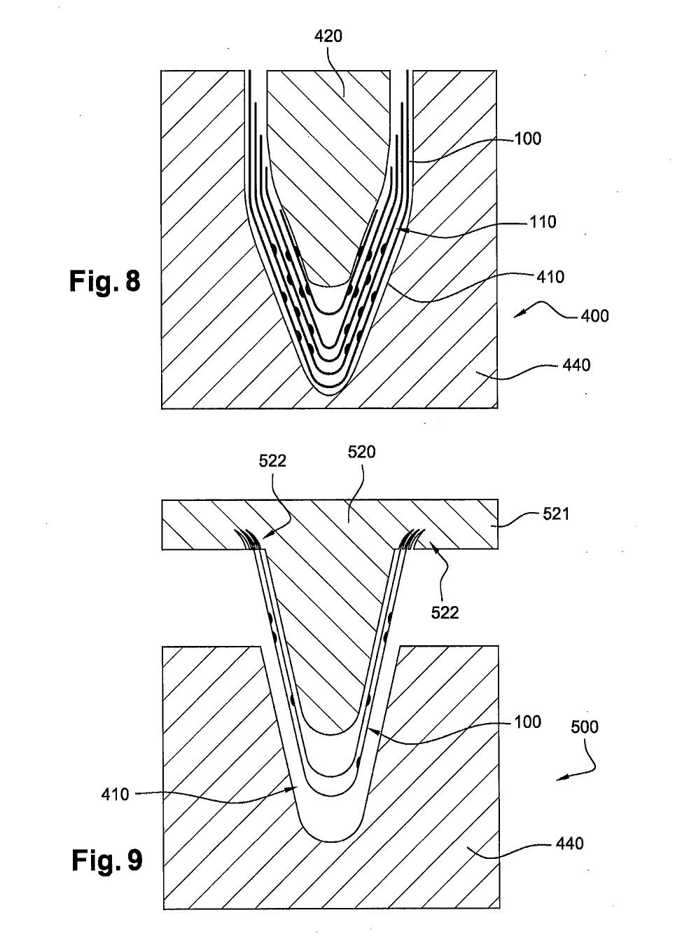

FIG. 8 shows a sectional view of the metal reinforcement of the leading edge of the turbine-engine blade according to a first example embodiment of the fourth step in the method shown in FIG. 3;

FIG. 9 shows a sectional view of the metal reinforcement of the leading edge of the turbine-engine blade according to a second example embodiment of the fourth step in the method shown in FIG. 3;

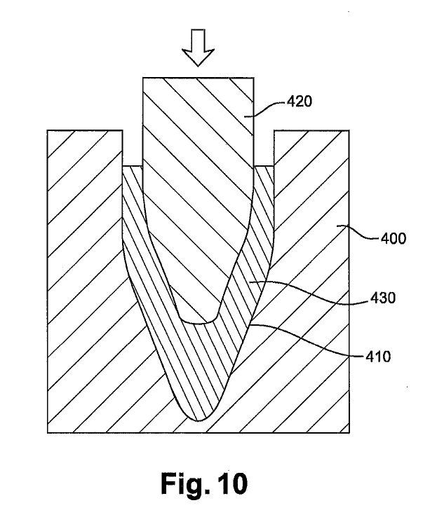

FIG. 10 shows a sectional view of the metal reinforcement of the leading edge of the turbine-engine blade obtained during the fifth step in the method shown in FIG. 3.

In all figures, common elements have the same reference numbers unless mentioned otherwise.

In the remainder of the description, the metal reinforcement of the leading edge or the trailing edge will be called a metal reinforcement or reinforcement indifferently.

FIG. 1 is a side view of a blade comprising a metal structural reinforcement of a leading edge obtained by means of the manufacturing method according to the invention.

Blade 10 shown is for example a mobile fan blade of a turbine-engine (not shown).

Blade 10 comprises an aerodynamic surface 12 extending along a first axial direction 14 between a leading edge 16 and a trailing edge 18 and along a second radial direction 20 approximately perpendicular to the first direction 14 between a root 22 and a tip 24.

The aerodynamic surface 12 forms the extrados face 13 and intrados face 11 of the blade 10, only the extrados face 13 of the blade 10 is shown in FIG. 1. The intrados 11 and the extrados 13 form the lateral faces of the blade 10 that connect the leading edge 16 to the trailing edge 18 of the blade 10.

In this embodiment, the blade 10 is a composite blade typically obtained by shaping a woven fibrous texture. For example, the composite material used may be composed of an assembly of woven carbon fibres and a resin matrix, the assembly being formed by moulding using an RTM (Resin Transfer Moulding) or a VARTM (Vacuum Resin Transfer Moulding) type resin injection method.

The blade 10 comprises a metal structural reinforcement 30 glued at its leading edge 16 and that extends both along the first direction 14 beyond the leading edge 16 of the aerodynamic surface 12 of the blade 10, and along the second direction 20 between the root 22 and the tip 24 of the blade.

As shown in FIG. 2, the structural reinforcement 30 matches the shape of the leading edge 16 of the aerodynamic surface 12 of the blade 10 that it extends to form a leading edge 31, called leading edge of the reinforcement.

Conventionally, the structural reinforcement 30 is a single-piece part comprising an approximately V-shaped section with a base 39 forming the leading edge 31 and extended by two lateral sides 35 and 37 matching the intrados 11 and the extrados 13 respectively of the aerodynamic surface 12 of the blade. The sides 35, 37 have a tapered or thinned section along the direction of the trailing edge of the blade.

The structural reinforcement 30 is a metal structural reinforcement and preferably a titanium-based structural reinforcement. Titanium has a high capacity to absorb energy created by shocks. The reinforcement is glued onto the blade 10 by means of glue known to those skilled in the art, for example such as epoxy glue.

This type of metal structural reinforcement 30 used for the reinforcement of the composite blade of the turbine-engine is disclosed particularly in patent application EP1908919.

The method according to the invention is used to produce a structural reinforcement like that shown in FIG. 2, FIG. 2 showing the reinforcement 30 in its final state.

FIG. 3 shows a block diagram illustrating the principal steps in a method 200 for producing a metal part in order for example to make a metal structural reinforcement 30 of the leading edge of a blade 10 as shown in FIGS. 1 and 2.

The first step 210 in the manufacturing method 200 is a step to cut out a plurality of flexible metal parts 101, 101′, 102, 102′ called metal foils in the following, from a thin titanium-based flexible metal sheet or metal foil. Two examples of metal foil cut outs are shown in FIGS. 4 and 5.

The metal foils 101, 101′, 102, 102′ as shown in FIGS. 4 and 5 are cut out using conventional means for cutting thin metal sheets, in other words with a thickness of less than 0.3 mm. Thus, the metal foils 101, 101′, 102, 102′ may for example be cut out by punch cutting means, shear cutting means or water jet, etc.

The geometry of the cut-out metal foils 101, 101′, 102, 102′ corresponds approximately to the developed shape of the final metal part to be made, for example such as a metal reinforcement 30 of a blade 10 leading edge shown in FIGS. 1 and 2.

The metal foils 101, 101′and 102, 102′ for making a turbine-engine blade reinforcement have a geometry approximately corresponding to the developed shape of the intrados face and the extrados face of the metal reinforcement 30.

The second step 220 in the manufacturing method 200 is a step to fix one or several metal wire(s) 105 on the metal foils 101, 101′, 102, 102′ cut out in the previous step. The metal wires 105 are fixed along an orientation defined as a function of the required directional structural stiffeners in the part to be made.

According to a first advantageous example embodiment of the invention shown in FIG. 6, the metal stiffening wire 105 is fixed on the foil 101, 101′, 102, 102′ by sewing the metal wire 105 using ad-hoc sewing means.

For producing a metal turbine-engine blade reinforcement 30, the metal wire 105 capable of structurally stiffening the reinforcement metal of blade is advantageously a titanium-based metal wire such as a silicon carbide and titanium (SiC—Ti)-based wire. However, the metal wire 105 that can structurally reinforce the metal reinforcement of the blade may also be a metal wire based on silicon carbide coated with boron (SiC—Boron) or coated with silicon (SiC—SiC).

According to a second embodiment of the invention (not shown), fixing of the metal stiffening wire on the foil 101, 101′, 102, 102′ is done by gluing the metal wire 105 on the metal foil 101, 101′, 102, 102′ or by spot welding the metal wire 105 on the foil.

The metal wires 105 fixed on the foil are thin wires with some flexibility suitable for manipulating them and fixing them on the metal foils. Advantageously, the diameter of the metal wires will vary approximately between 0.1 mm and 0.3 mm.

The third step 230 in the manufacturing method 200 is a step to make the metal pockets 100 as shown in FIG. 7 from flexible metal foils 101, 101′, 102, 102′ reinforced by metal stiffening wires 105.

According to the first example cut-out of metal foils 101, 101′ shown in FIG. 4 for producing a turbine-engine blade reinforcement, the pockets 100 are made by superposing a first foil 101 corresponding to the geometry of the intrados face of the metal reinforcement 30 with a second foil 101′ corresponding to the geometry of the extrados face of the metal reinforcement 30.

The two reinforced foils 101, 101′ are then assembled at least at a common edge 105 approximately corresponding to the profile of the leading edge 31 of the reinforcement 30, for example by gluing or by welding means so as to form a reinforced metal pocket 100.

The two metal foils 101, 101′ made of titanium may be glued simply by heating the metal foils 101, 101′ superposed under a slightly pressurised atmosphere.

The weld at the edge 105 is done by known welding means capable of welding two thin titanium metal sheets. Thus, for example, the two foils 101, 101′ are assembled by spot welds 111 using an electric spot welding method.

According to the second method of cutting out the metal foils 102, 102′ shown in FIG. 5, the two foils 102, 102′ forming the intrados and extrados faces of the metal reinforcement 30 are held fixed at a junction zone 103 and possibly supported by two support tabs 104 on each side of the junction zone 103 thus stabilising the metal foils after the cutting step 210, for example during miscellaneous manipulation operations.

The pocket 100 is manufactured by folding two foils 102, 102′ at the junction zone 103 so as to superpose the two foils 102, 102′ on each other.

During the folding operation, the two support tabs 104 are withdrawn by cutting means.

In the same way as in the first example described above, the reinforced pocket 100 is done by making a connection using a gluing method or a welding method, at least at the edges 105 of the two foils 102, 102′ defining the profile of the leading edge of the reinforcement.

The fourth step 240 positions the metal reinforced pockets 100 in a shaping tool 400, 500 by superposing or stacking the different pockets 100.

The shaping tool 400 shown schematically in FIG. 8 comprises a die 440 with a cavity 410 corresponding to the final external shape of the metal reinforcement 30 and a punch 420 corresponding to the final internal shape of the metal reinforcement of the leading edge.

According to a first example embodiment shown in FIG. 8, the different pockets 100 are positioned in the cavity 410 of the die 440.

Since the metal pockets 100 are flexible and cut out to a geometry approximately corresponding to the developed shape of the metal blade reinforcement, the positioning step consists simply of successively nesting the different reinforced metal pockets 100 forming the preform of the blade reinforcement. Therefore making the preform from a plurality of flexible and deformable metal pockets makes it possible to deposit metal material matching a complex shape of a cavity 410 with two curvatures along two distinct planes.

According to a second embodiment shown in FIG. 9, the different pockets 100 are positioned on the punch 420.

To achieve this, the shaping tool 500 comprises a die 440 with a cavity 410 similar to the cavity in the first example embodiment, and a punch 520 corresponding to the final internal shape of the metal reinforcement of the leading edge and in its upper part, comprising two shoulders 521 on each side of the V-shape 522 corresponding to the final internal shape of the metal stiffener. The face of the shoulders 521, facing towards the inside of the tooling 500, comprises notches 522 distributed around the entire length of the punch 520 (i.e. along the longitudinal axis of the punch), capable of containing the metal pockets inserted in the notches 522 and holding them in position. These notches 522 are advantageously slits formed such that once the metal pockets 100 have been inserted into the slits 522 of the punch 520, they can no longer separate from them under the effect of gravity. According to this second embodiment, the reinforced metal pockets 100 are put into position on the punch 520 by successively positioning the different pockets in the notches 522 of the punch 520 located on each side of the V-shape of the punch 520.

Before this fourth step 240, the manufacturing method may comprise an additional step to make a preform 110 obtained by successively nesting a plurality of pockets 10 on a shaping template.

Advantageously, the pockets 100 are made from foils with different widths L such that the preform 110 formed by stacking the different pockets respects the material thickness requirements necessary to make the final part (i.e. the metal reinforcement 30).

It is also envisaged that the thicknesses of the preform can be optimised by stacking flexible metal pockets with different thicknesses, in other words with thicknesses varying between approximately 0.05 and 0.3 mm.

The different size pockets 100 can also be used to simply make an easily transportable stack, particularly by successive stacking of the pockets 100 in decreasing order of size as shown in FIG. 8. Thus, the largest pocket forms the external surface of the preform 110 in contact with the cavity 410 and the smallest pocket forms the internal surface of the preform 110 in contact with the mating cavity 420. Thus, the different pockets 100 of the preform are surrounded and held in place by the largest external pocket.

However, a stack different from that presented above is also envisaged.

According to another example embodiment, an insert can be inserted between two successive reinforced metal pockets 100 during the stacking operation, so as for example to provide a larger material overthickness, a specific stiffener made from a different material or to make a hollow metal reinforcement.

For example, the insert may be a solid insert made using a forging, machining process, or by casting, or by a insert woven using metal wires, for example titanium wires and/or wires based on silicon carbide and titanium (SiC—Ti), and/or wires based on silicon carbide and coated with boron (SiC—Boron), or coated with silicon carbide (Sic—Sic).

Regardless of the nature of the material used to make the insert inserted between the different reinforced metal pockets, this material has to be compatible with the nature of the material used to make metal pockets and it must have properties that enable superplastic forming and diffusion welding.

A hollow metal reinforcement (not shown) is done using an insert which is a temporary insert made from a material different from the material from which the metal foils 100 are made.

A “temporary insert” means an insert that is not intended to be permanent, and that is only useful for making the hollow metal reinforcement of the leading edge. Therefore, the temporary insert is not present in the metal reinforcement in its final state and does not make any contribution to the mechanical properties of the metal reinforcement.

For example, the temporary insert is done from a material capable of resisting a high temperature of the order of 900° C., a high pressure of the order of 1000 bars and is compatible with the materials from which the metal foils 100 are made, so that there are no impurities or oxidation in the preform 110.

It must also be possible to etch the material used for the temporary insert by dissolution using a chemical agent.

Advantageously, the temporary insert is done from copper, quartz or silica.

The shape of the temporary insert incorporated into the stack of metal foil pockets 100 depends on the shape of the required final internal cavity.

The fifth step 250 in the manufacturing method 200 is a Hot Isostatic Pressing (HIP) step of the different reinforced metal pockets positioned in the shaping tool 400 as shown in FIG. 8.

Hot isostatic pressing is a very widely used manufacturing method to reduce the porosity of metals and have an influence on the density of many materials, for example such as materials in the form of a pre-compacted powder. The isostatic pressing method can also improve mechanical properties and useability of materials.

Isostatic pressing is done at high temperature (conventionally between 400° C. and 1400° C. and of the order of 1000° C. for titanium) and at isostatic pressure.

Thus application of heat combined with the internal pressure eliminates voids in the preform, and microporosities by means of a combination of plastic deformation, creep and diffusion welding so as to form a solid part 430.

The solid part 430 resulting from the isostatic pressing step comprises internal and external profiles of the metal reinforcement 30. The solid part 430 is then removed from the tooling 400.

The isostatic pressing step is done under a vacuum, advantageously under a secondary vacuum either in a welded tool in which the secondary vacuum is created, or inside a bag in the autoclave, the choice of the method depending on the number of parts to be produced. The secondary vacuum can avoid the presence of oxygen in the tooling and at the fibrous structure, during the titanium isostatic pressing step.

The tool 400, 500 is done from a mechanical alloy called a super-alloy or high performance alloy.

The isostatic pressing step 250 may comprise a prior cleaning, degreasing step and/or an etching step of the different reinforced metal pockets 100 so as to eliminate residual impurities in the preform. Advantageously, the impurity cleaning step is done by dipping the assembly in a cleaning agent bath or a chemical agent bath.

When manufacturing a hollow metal reinforcement, the method according to the invention may include an additional step in which the insert introduced during the stacking step of the different metal pockets is etched. Etching is done using a chemical agent capable of etching the material from which the insert is done. Etching of the temporary insert dissolves the temporary insert so that the space released by the dissolved insert forms the internal cavity in the metal reinforcement. Advantageously, the etching step is done by dipping the final part 430 into a bath containing the chemical agent that will dissolve the insert. The chemical agent may for example be an acid or a base.

Advantageously, the chemical agent is capable of dissolving copper, quartz or even silica.

In combination with these main manufacturing steps, the method according to the invention may also comprise a finishing and reworking machining step on the final part obtained at the exit from the tooling so as to obtain the reinforcement 30. This reworking step includes:
a step for reworking the profile of the base 39 of the reinforcement 30 so as to refine it and particularly to refine the aerodynamic profile of the leading edge 31;
a reworking step of the sides 35, 37; this step consists particularly of trimming the sides 35, 37 and thinning the intrados and extrados sides;
a finishing step in order to obtain the required surface condition.

In combination with these main manufacturing steps, the method according to the invention may also comprise non-destructive testing steps of the reinforcement 30 to check the geometric and metallurgical conformity of the assembly obtained. For example, non-destructive tests may be made using an X-ray process.

This invention has been described principally with the use of titanium-based metal wires and metal foils; however the manufacturing method is also applicable with any metal material with properties enabling superplastic forming and/or diffusion welding, for example such as aluminium.

The invention has been described particularly for making a metal reinforcement of a composite turbine-engine blade; however, the invention is also applicable for making a metal reinforcement of a metal turbine-engine blade.

The invention has been described particularly for making a metal reinforcement of a leading edge of a turbine-engine blade; however the invention is also applicable for making a metal reinforcement of a trailing edge of a turbine-engine blade or making a metal reinforcement of a propeller made of composite or metal material.

The invention has been described particularly with reference to the use of metal wires as directional structural stiffeners positioned in the mass of the part to be made; however, the invention is also applicable with the use of metal cables as directional structural stiffeners. The metal cables are formed from a plurality of twisted, woven metal strands or strands wound spirally around the longitudinal axis of the cable. Advantageously, each metal strand forming the cable has a diameter of less than 0.1 mm. For example, the metal cables may comprise between 20 and 30 wound strands. The use of metal cables formed from a plurality of wound metal strands can thus give a large section cable that is flexible and manually deformable when cold (i.e. for example at ambient temperature) and therefore facilitate positioning of the different reinforced metal pockets in a shaping tool.

The other main advantages of the invention are:
reduction of production costs;
reduction of production time;
simplification of the manufacturing procedure;
reduction of material costs.

1. Method of producing a reinforced metal part, comprising:
cutting out a plurality of metal foils corresponding approximately to a developed shape of said metal part to be made, from at least one flexible metal sheet,
fixing at least one metal stiffening wire on at least one metal foil among said plurality of foils, said metal wire being positioned as a function of the orientation of the desired structural stiffener on the metal part to be made;
making a plurality of reinforced metal pockets, each metal pocket being made from two reinforced metal foils;
positioning said plurality of reinforced metal pockets in a shaping tool;
performing a hot isostatic pressing of said reinforced metal pockets to cause bonding of said metal pockets and said metal stiffening wire so as to obtain said metal part including a structural reinforcement.

2. The method according to claim 1, wherein said metal reinforcement is a metal reinforcement of a leading edge or trailing edge of a turbine-engine blade or a metal reinforcement of a propeller such that said reinforced metal part obtained during said isostatic pressing step is a reinforced metal reinforcement of a turbine-engine blade.

3. The method according to claim 1, wherein said making of a plurality of metal pockets is done by superposition of two distinct metal foils and then by assembly of at least one edge of said metal foils by connecting means.

4. The method according to claim 1, wherein said making a plurality of metal pockets is done by folding a junction zone between two metal foils and then by assembling at least one edge of said two metal foils by connecting means.

5. The method according to claim 1, wherein said fixing of at least one metal stiffening wire onto at least one metal foil is done by sewing means.

6. The method according to claim 1, wherein said fixing of a metal stiffening wire onto at least one metal foil is done by gluing means and/or welding means.

7. The method according to claim 1, wherein said fixing of a metal stiffening wire onto at least one metal foil is done with a metal wire with a thickness varying between 0.05 mm and 0.3 mm.

8. The method according to claim 1, wherein said fixing of a metal stiffening wire onto at least one metal foil done using a metal wire based on titanium and/or wires based on silicon carbide coated with titanium and/or wires based on silicon carbide coated with boron, and/or wires based on silicon carbide coated with silicon carbide.

9. The method according to claim 1, wherein said positioning of each of said reinforced metal pockets is done by stacking each of said reinforced metal pockets in a cavity of a die of said shaping tool.

10. The method according to claim 1, wherein said positioning of each of said reinforced metal pockets is done by embedding each of said reinforced metal pockets in a plurality of notches arranged in a punch of said shaping tool.

11. The method according to claim 1, wherein the reinforced metal part is a metal reinforcement of a turbine-engine blade.
